(19) United States
(12) Patent Application Publication
(10) Pub. No.: US 2015/0041072 A1
(43) Pub. Date: Feb. 12, 2015

(54) WINDOW CURTAIN ASSEMBLY

(71) Applicant: CHING FENG HOME FASHIONS CO., LTD., Fuxing Shiang (TW)

(72) Inventors: SHENG-YING HSU, Fuxing Shiang (TW); WU-CHUNG NIEN, Fuxing Shiang (TW)

(73) Assignee: CHING FENG HOME FASHIONS CO., LTD., Fuxing Shiang (TW)

(21) Appl. No.: 14/077,206

(22) Filed: Nov. 11, 2013

(30) Foreign Application Priority Data
Aug. 9, 2013 (TW) 102214959

(51) Int. Cl. E06B 9/38

(52) U.S. Cl. CPC E06B 9/38
USPC 160/84.05

(57) ABSTRACT

A window curtain assembly includes a head box, and a honey-comb curtain is connected to the head box. The head box has a first securing member on a face thereof, and the honey-comb curtain has multiple first connection portions formed along two lateral sides thereof. A shade made from fabric has a second securing member which is connected to the first securing member, so that the shade is mounted on the honey-comb curtain. Multiple second connection portions are formed on the shade and located in correspondence with the first connection portions. The first and second connection portions are sewn together. The shade is folded into multiple folded sections and no operation cords are exposed.

### FIELD OF THE INVENTION

The present invention relates to a window curtain assembly, and more particularly, to a window curtain assembly having a Roman shade without operation cords needed.

### BACKGROUND OF THE INVENTION

The conventional window curtains or blinds are usually operated in horizontal or vertical direction, wherein the horizontally operated window curtain uses cords to move the blinds in horizontal direction. The vertically operated window curtain comprises a head box and a bottom bar, and a honey-comb curtain is connected between the head box and the bottom bar. By operating the operation cords, the honey-comb curtain is lifted or lowered to adjust the light from outside. The Roman shade is one of the common seen vertical window curtains and comprises a shade connected to the head box. Multiple passages are transversely formed along the shade and each passage receives a tube. Each sewing portion of the passages has multiple lugs fixed thereto and each lug has a hole so that the cords extending from the head box extend through the holes. The operation cords are hanging on one side of the shade so that the user can hold the operation cords and operate the shade. The tubes in the passages are lifted to fold the shade by operating the operation cords. However, the exposed operation cords reduce the aesthetic features and could be dangerous if kids carelessly play the cords around their necks.

The present invention intends to provide an improved window curtain assembly which combines the conventional honey-comb window curtain and a Roman shade, wherein no exposed cords are needed.

### SUMMARY OF THE INVENTION

The present invention relates to a window curtain assembly and comprises a head box. A honey-comb curtain has a top end connected to the head box and the head box has a first securing member on a face thereof. The honey-comb curtain has multiple first connection portions formed along two lateral sides thereof. A shade made by a piece of fabric has a second securing member on one end thereof. The second securing member is connected to the first securing member. Multiple second connection portions are formed on the shade and located corresponding to the first connection portions. The first and second connection portions are secured to each other by sewing.

The primary object of the present invention is to provide a window curtain assembly with a shade mounted to the honey-comb curtain, wherein there will be no operation cords exposed.

The present invention comprises a honey and a shade which is mounted to the honey-comb curtain, the operation cords are hidden in the honey-comb curtain so that no operation cords are exposed. Therefore children cannot play and the operation cords so as to avoid dangerous situations mentioned before.

Air is stored in the spaces in the honey-comb curtain and isolates heat and Ultra-Violet rays from entering the room.

Because no operation cords are exposed, the window curtain assembly meets the requirements of aesthetic features.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the window curtain assembly of the present invention;

FIG. 2 is an exploded view to show the window curtain assembly of the present invention;

FIG. 3 is a side view to show the window curtain assembly of the present invention;

FIG. 4 is an enlarged view to show the connection of the first and second connection portions of the window curtain assembly of the present invention;

FIG. 5 is a side view to show the second embodiment of the window curtain assembly of the present invention, and

FIG. 6 is an enlarged view to show the connection of the first and second connection portions of the second embodiment of the window curtain assembly of the present invention.

### DETAILED DESCRIPTION OF THE PREFERRED EMBODIMENT

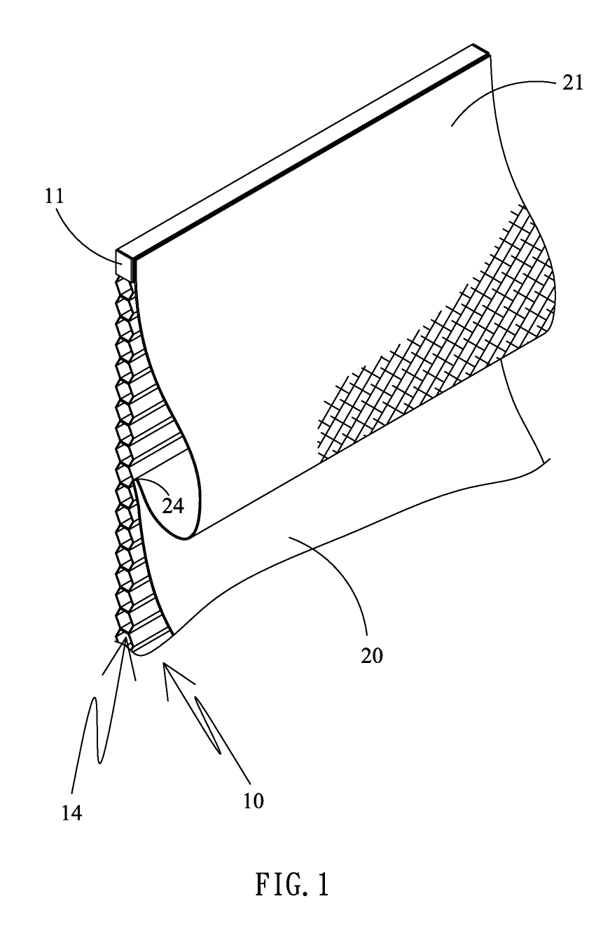

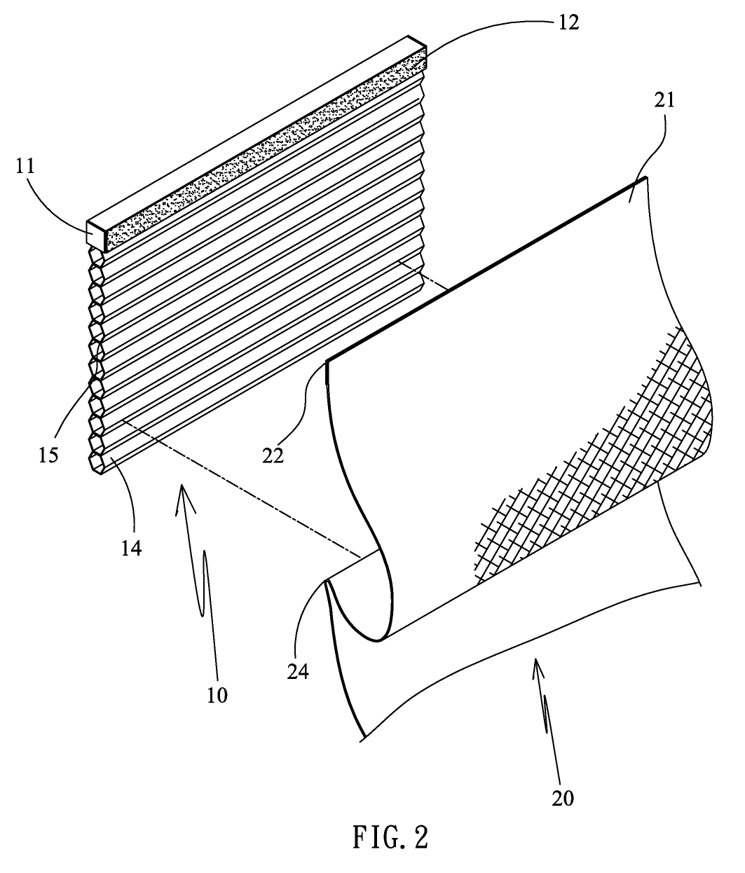

Referring to FIGS. 1 and 2, the window curtain assembly of the present invention comprises a head box 11, a honey-comb curtain 14 and a shade 20, wherein the honey-comb curtain 14 has a top end connected to the operation mechanism (not shown) in the head box 11 such that the honey-comb curtain 14 can be lifted or lowered by operation of the operation mechanism. The head box 11 has a first securing member 12 on the inner face thereof, and the honey-comb curtain 14 has multiple first connection portions 15 formed along two lateral sides thereof.

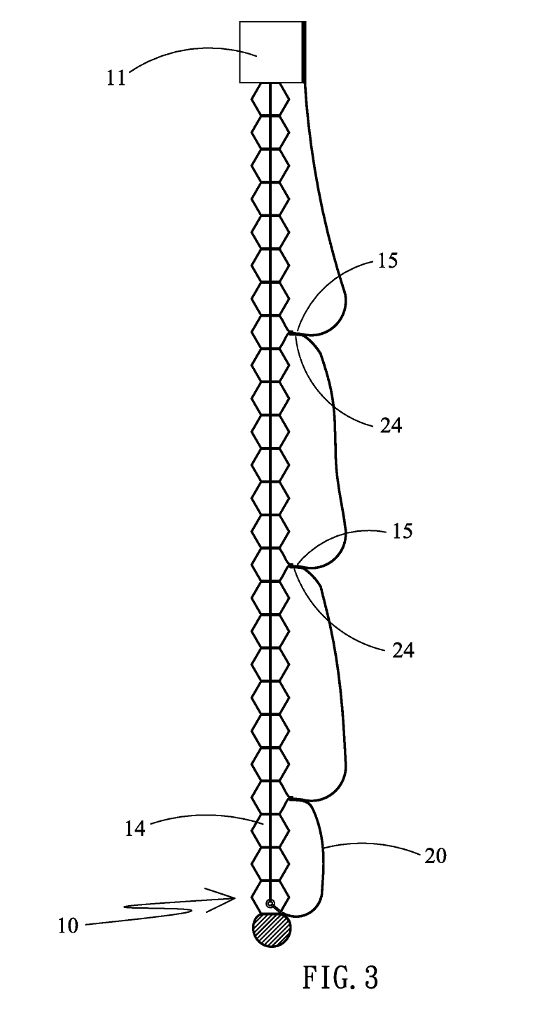

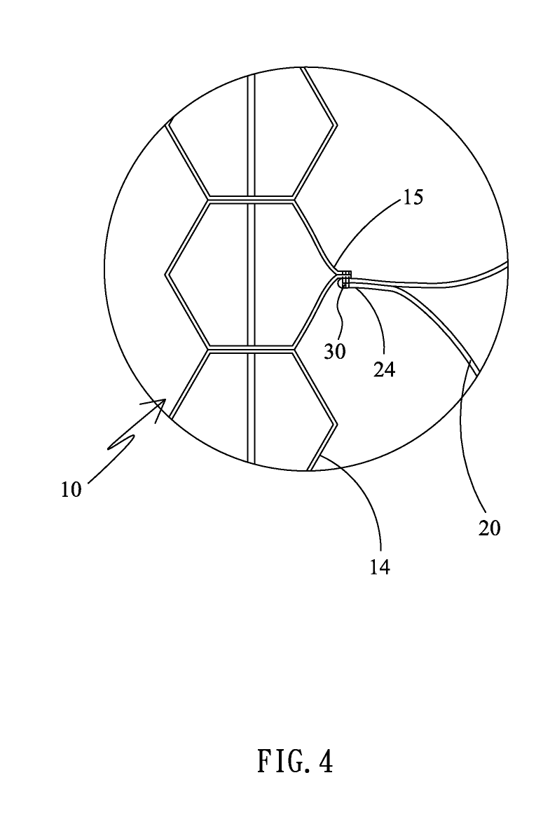

The shade 20 is made by at least one piece of fabric and has a second securing member 22 on an outer face of one end thereof. The second securing member 22 is connected to the first securing member 12. The first and second securing members 12, 22 are hook-loop pieces in this embodiment. Multiple second connection portions 24 are formed on the shade 20 and located corresponding to the first connection portions 15. The distance between any two second connection portions 24 is longer than the distance between the first connection portions 15, so that the second connection portions 24 are in a folded form as shown in FIG. 3. The multiple folded first connection portions 15 are formed on the shade 20 as a conventional Roman shade. As shown in FIGS. 3 and 4, each of the second connection portions 24 includes a part which is composed of two overlapped portions of the shade 20, and the part is connected to the underside of the first connection portion corresponding thereto by sewing threads 30.

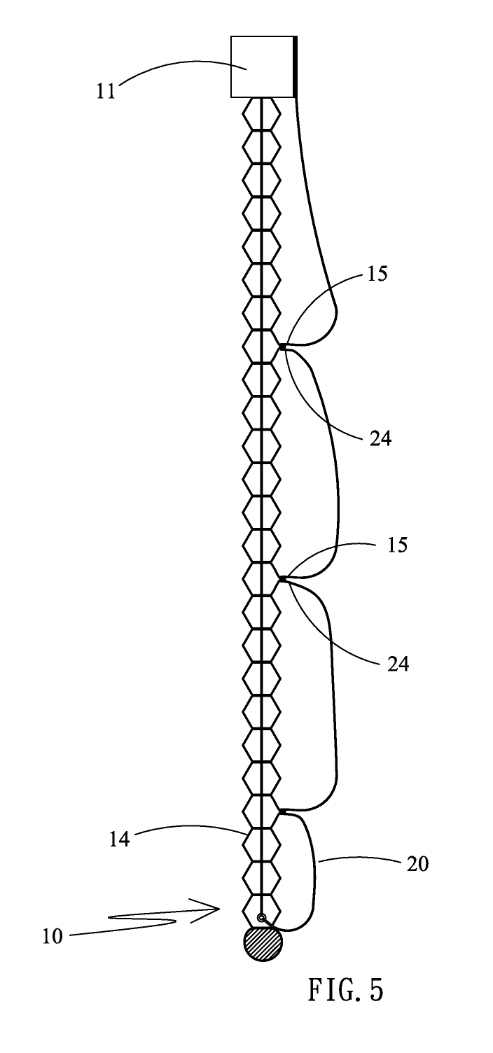

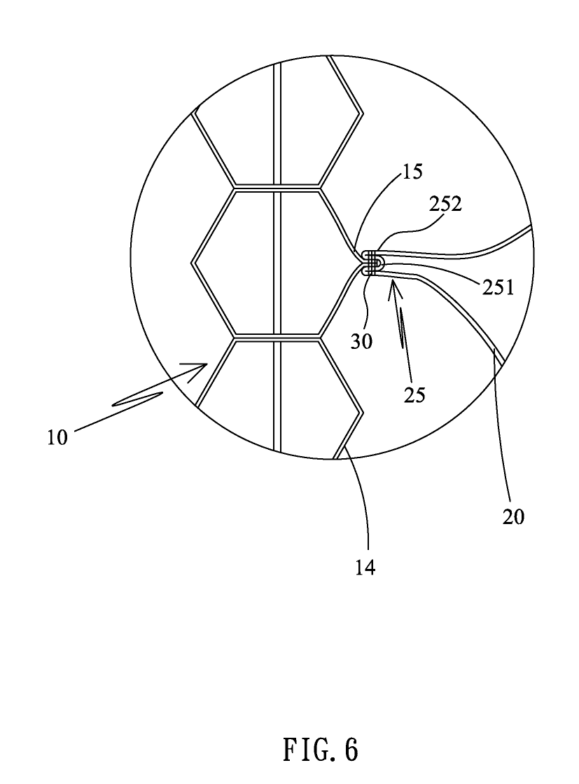

As shown in FIGS. 5 and 6, the second embodiment of the present invention is disclosed, wherein each of the second connection portions 25 includes a part having a U-shaped opening 251 which is defined by two extension sides 252 and a bridge portion connected between the two extension sides 252. The two extension sides 252 are respectively located on two respective outsides (top and bottom) of the first connection portion 15. The first connection portion 15 is inserted into the U-shaped opening 251. The two extension sides 252 are securely connected to the first connection portion 15 by sewing threads.

Because there is no operation cords exposed, so that the window curtain assembly of the present invention can avoid from dangerous situations such as the children wrap the operation cords on their necks.

While we have shown and described the embodiment in accordance with the present invention, it should be clear to those skilled in the art that further embodiments may be made without departing from the scope of the present invention.

What is claimed is:

1. A window curtain assembly comprising:
a head box;
a honey-comb curtain having a top end connected to the head box, the head box having a first securing member on a face thereof, the honey-comb curtain having multiple first connection portions formed along at least two lateral sides thereof, and
a shade made of at least one piece of fabric and having a second securing member on an end thereof, the second securing member connected to the first securing member, and multiple second connection portions formed on the shade and located at respective positions corresponding to the first connection portions, the first and second connection portions being sewn together;
wherein each second connection portion comprises at least one overlap region in which the fabric of the shade overlaps onto itself, and the overlap region is sewn onto the corresponding first connection portion.

2. The window curtain assembly as claimed in claim 1, wherein the first and second securing members are hook-loop pieces.

3. The window curtain assembly as claimed in claim 1, wherein each overlap region is sewn to an underside of the corresponding first connection portion.

4. The window curtain assembly as claimed in claim 1, wherein each of the second connection portions includes a part having a U-shaped opening which is defined by two overlap regions and a bridge portion connected between the two overlap regions, the two overlap regions respectively located on two respective outsides of the first connection portion, the first connection portion inserted into the U-shaped opening, and the two overlap regions are sewn to the first connection portion.
